(19) United States
(12) Patent Application Publication
(10) Pub. No.: US 2013/0019977 A1
(43) Pub. Date: Jan. 24, 2013

(54) FAUCET ASSEMBLY WITH INSULATING CORE

(71) Applicant: CHIEN-TE HUNG, CHANGHWA (TW)

(72) Inventor: CHIEN-TE HUNG, CHANGHWA (TW)

(73) Assignee: KENT PLASTIC CO., LTD., CHANGHWA (TW)

(21) Appl. No.: 13/188,829

(22) Filed: Jul. 22, 2011

(51) Int. Cl. F16K 51/00

(52) U.S. Cl. 137/801

(57) ABSTRACT

A faucet assembly with an insulating core is disclosed. The insulating core has an inlet, an outlet and a socket portion communicating the inlet and the outlet, and is made of polyoxymethylene (POM). The faucet assembly has a controlling valve configured to be received in the socket portion for controlling the inlet and the outlet to communicate with or separate from each other and a metal body configured to contain the insulating core therein and having a knob for operating the controlling valve to communicate or separate the inlet and the outlet with or from each other, thereby allowing or disallowing water supply. The insulating core serves to insulate water flowing therethrough from the metal body thereof in terms of heat transmission and metal contamination.

### BACKGROUND OF THE INVENTION

1. Technical Field

The present invention relates to faucets, and more particularly, to a faucet assembly having an insulating core therein, wherein the insulating core serves to not only insulate water therein from any metals substances released from a metal faucet body, but also insulate the metal faucet body from heat generated by the water flowing through the insulating core, thereby preventing a user touching the faucet body from getting scalded.

2. Description of Related Art

Water is indispensable for people to live. With the improvement of material life, people have paid more and more attention to water quality. In the context of such concern, choosing faucets that supply water has become an issue. Traditionally, a faucet is made of metal through a casting or forging process in order to maximize design possibilities and minimize the costs for mass manufacturing. The metal materials used for this purpose, however, mostly contain lead, more or less, and thus may bring the risk of metal contamination to water passing through the faucet, in turning risking the health of people who drink the contaminated water.

In addition, the conventional metal faucet tends to become hot when supplying hot water for a prolonged period because metal has a high thermal conductivity. People who accidently touch such a heated faucet may get seriously scalded, so the conventional metal faucet is particularly dangerous to the elders and children.

Hence, there is a need for a faucet assembly having an insulating core to insulate water flowing therethrough from a metal body thereof in terms of heat transmission and metal contamination. The faucet assembly should be economic and easy to produce, and suitable to normal water supply devices, and particularly, drinking water dispensers.

### SUMMARY OF THE INVENTION

In view of such a need, the inventor of the present invention has contemplated developing a novel device and eventually invented and herein proposes a faucet assembly with an insulating core, wherein the insulating core is compatible to various existing faucet structures and assures users with clean water and safe water use.

According to the present invention, the faucet assembly with the insulating core comprises:

the insulating core having an inlet, an outlet and a socket portion communicating the inlet and the outlet, and being made of polyoxymethylene (POM);

a controlling valve configured to be received in the socket portion for controlling the inlet and the outlet to communicate with or separate from each other; and

a metal body configured to contain the insulating core therein and having a knob for operating the controlling valve to communicate or separate the inlet and the outlet with or from each other, thereby allowing or disallowing water supply.

One objective of the present invention is to provide the faucet assembly wherein the insulating core serves to separate water flowing through the faucet assembly from the metal body, so as to eliminate metal contamination and thereby ensure human health.

Another objective of the present invention is to provide the faucet assembly wherein the insulating core uses ribs at the periphery thereof to enforce the insulating core in structure while minimizing the weight and material use of the insulating core, thereby reducing the manufacturing costs.

Still another objective of the present invention is to provide the faucet assembly wherein the insulating core is thermally resistant and thermally insulating so as to effectively block thermal transmission between the insulating core and the metal body, so as to prevent a user from being scalded by the metal body that would otherwise be heated by hot water flowing through the insulating core.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a faucet assembly with an insulating core according to the present invention;

FIG. 2 is an exploded view of the faucet assembly of FIG. 1;

FIG. 3 is a partially cutaway view of the insulating core according to the present invention;

FIG. 4 is cross-sectional view of faucet assembly of the present invention with water flowing therethrough; and

FIG. 5 is another embodiment of the faucet assembly of the present invention.

### DETAILED DESCRIPTION OF THE INVENTION

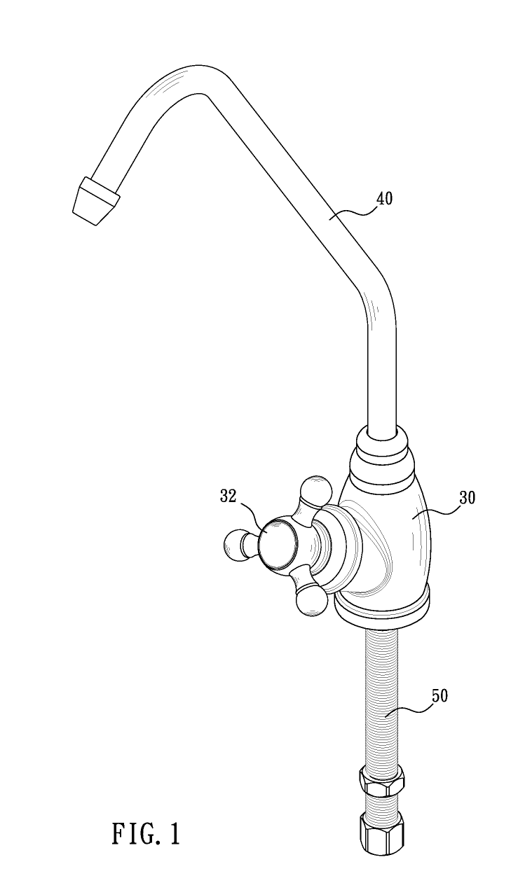

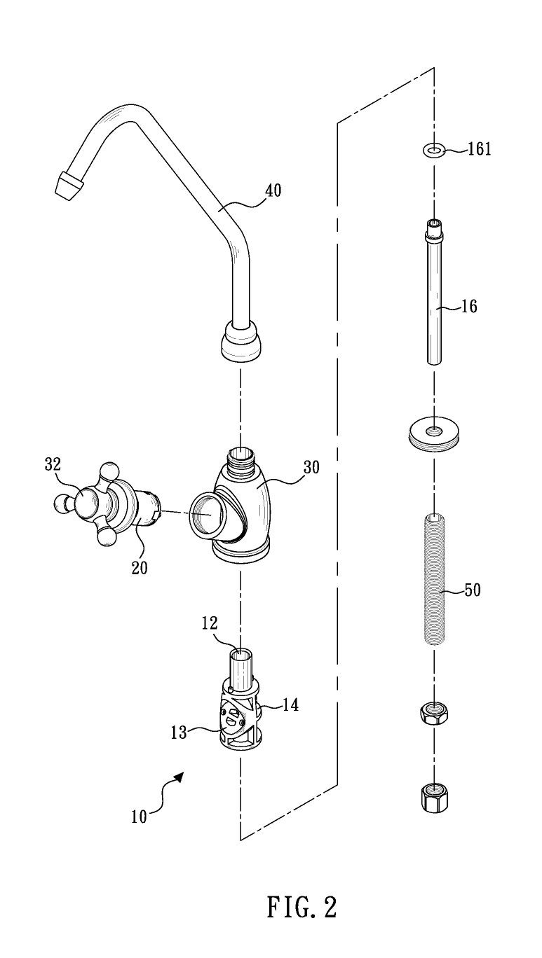

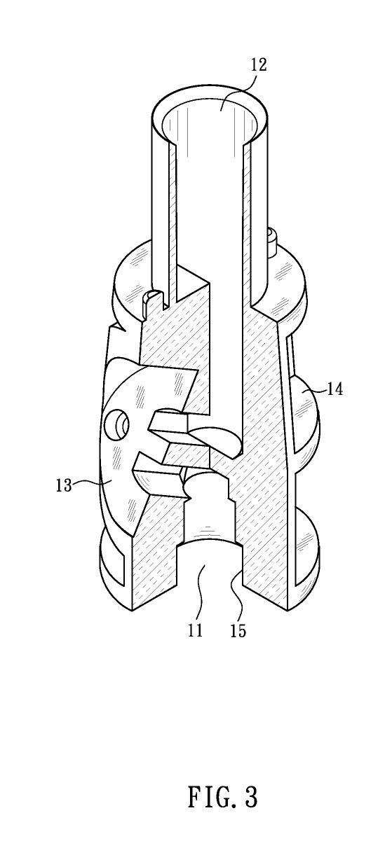

Referring to FIGS. 1 through 3, the present invention provides a faucet assembly with an insulating core.

The insulating core 10 is made of polyoxymethylene (POM), and has an inlet 11 and an outlet 12. The insulating core 10 further has a socket portion 13 formed on a periphery thereof for communicating the inlet 11 and the outlet 12. Along the periphery of the insulating core 10 a plurality of ribs 14 are formed for structurally enforcing the insulating core 10 while minimizing the weight and material use of the insulating core 10, thereby reducing the manufacturing costs.

The faucet assembly also has a controlling valve 20 that is configured to be received in the socket portion 13, for controlling the inlet 11 and the outlet 12 to communicate with or separate from each other.

The faucet assembly is provided with a metal body 30 that defines an accommodating space 31 to contain the insulating core 10. The metal body 30 further has a knob 32 for operating the controlling valve 20 to communicate or separate the inlet and the outlet with or from each other, thereby allowing or disallowing water supply. Generally, by operating the knob 32, the controlling valve 20 can be driven to change the magnitude of a water flow flowing therethrough.

For facilitating its assembling with an external water source, the inlet 11 may further include an O-shaped groove 15, an O-ring 161 fittingly received in the O-shaped groove 15 and a connecting pipe 16 made of polyoxymethylene (POM) and sealed with the inlet 11 by the O-ring 161. The connecting pipe 16 may be directly connected to a water source (not shown) or be arranged inside a metal water supply pipe 50. Moreover, the outlet 12 may be affixed with a spout tube 40 also made of polyoxymethylene (POM). In such a case, water coming from the water source of the metal water supply pipe 50 is allowed to be provided at the spout tube 40 without contacting any metal components.

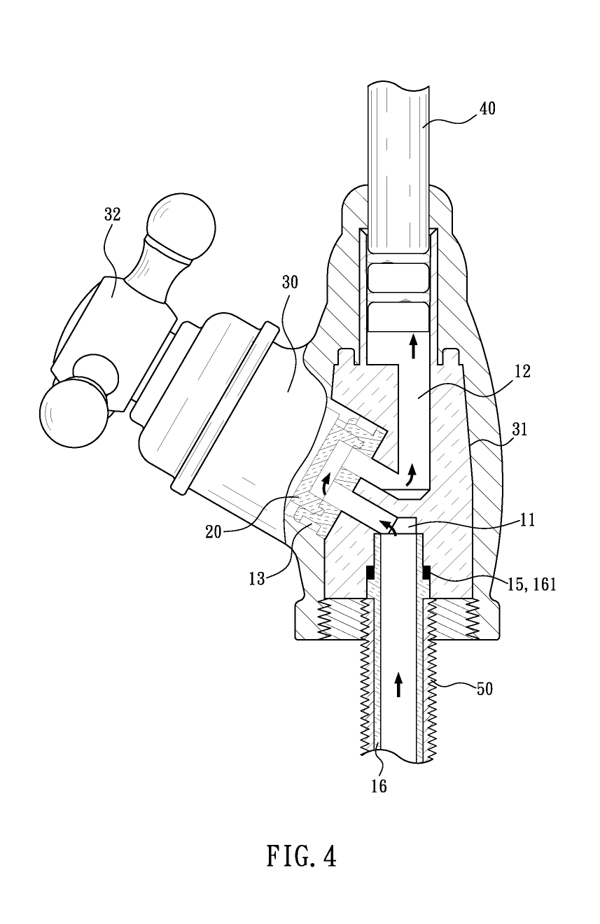

Particularly, as shown in FIG. 4, when a user rotates the knob 32, the knob 32, according to the extent it is rotated, drives the controlling valve 20 to open, so water coming from the connecting pipe 16 and entering the insulating core 10 is allowed to pass through the controlling valve 20 and reach the outlet 12, before spouting out from the spout tube 40 affixed to the outlet 12. During the foregoing process, water only contacts the components made of polyoxymethylene (POM), which is safe to human health by eliminating the risk of metal contamination.

Moreover, the ribs 14 provided at the periphery of the insulating core 10 not only enforces the mechanical strength of the insulating core 10, but also improves the insulating core 10 in thermal insulation. Thus, when hot water passes through the insulating core 10, as polyoxymethylene (POM) itself has the capability of thermal insulation, the clearances formed by the ribs 14 between the insulating core 10 and the metal body 30 also serve to prevent the heat of the hot water from being conducted to the metal body 30. Therefore, the metal body 30 can be maintained at the ambient temperature even when the faucet assembly continuously supplies hot water for a prolonged period. As a result, the user is freed from the danger of getting scalded by the metal body 30 that would otherwise be hot.

The disclosed faucet assembly is particularly useful when it is desired to keep drinking water after filtration from metal contamination. In such an application, the connecting pipe 16 made of POM may be inserted into a metal water supply pipe 50 to connect a source of filtered water directly, and work with the insulating core 10 as well as the spout tube 40 that are also made of POM, to completely separate the filtered drinking water from the metal pipe 50 and metal body 30. By doing so, not only can the risk of metal contamination to the supplied water be eliminated, but also the metal body 30 can be protected from getting rusted due to its long-term contact with water, thereby extending the service life of the metal body 30.

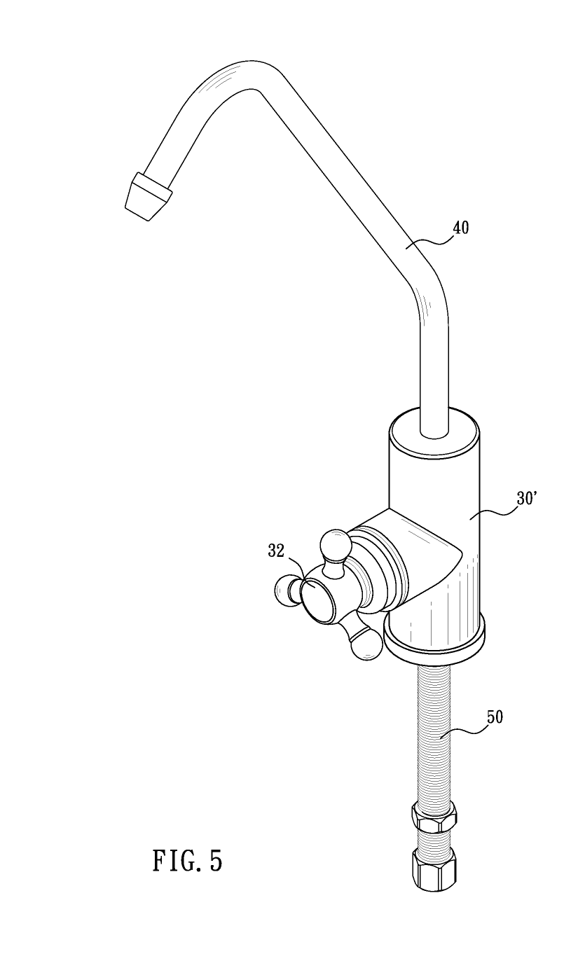

The present invention is beneficial because the insulating core 10 can be easily incorporated into existing faucets by moderately modifying the design and manufacturing process. As shown in FIG. 5, the insulating core 10 may be applied to another faucet assembly with a different metal body 30′.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A faucet assembly with an insulating core, the faucet assembly comprising:
the insulating core having an inlet, an outlet and a socket portion communicating the inlet and the outlet, and being made of polyoxymethylene (POM);
a controlling valve configured to be received in the socket portion for controlling the inlet and the outlet to communicate with or separate from each other; and
a metal body configured to contain the insulating core therein and to operate the controlling valve to communicate or separate the inlet and the outlet with or from each other, thereby allowing or disallowing water supply.

2. The faucet assembly of claim 1, wherein the inlet is connected with a connecting pipe made of polyoxymethylene (POM) and the connecting pipe is connected with a water source.

3. The faucet assembly of claim 2, wherein the inlet has an O-shaped groove for fittingly receiving an O-ring, so that the inlet and the connecting pipe are sealed with the O-ring.

4. The faucet assembly of claim 1, wherein the insulating core has a periphery provided with a plurality of ribs for structurally enforcing the insulating core.

5. The faucet assembly of claim 1, wherein the metal body is provided with a knob to be operated for driving the controlling valve to allow or disallow water supply.
